(19) United States
(12) Patent Application Publication
(10) Pub. No.: US 2016/0145483 A1
(43) Pub. Date: May 26, 2016

(54) WELL TREATMENT

(71) Applicant: SCHLUMBERGER TECHNOLOGY CORPORATION, Sugar Land, TX (US)

(72) Inventors: Bruno Lecerf, Houston, TX (US); Zinaida Yurievna Usova, Sugar Land, TX (US); Dmitriy Usoltsev, Richmond, TX (US)

(21) Appl. No.: 14/554,866

(22) Filed: Nov. 26, 2014

(51) Int. Cl. C09K 8/42; E21B 43/26; E21B 33/12

(52) U.S. Cl. CPC C09K 8/426; E21B 33/12; E21B 43/26; C09K 2208/08

(57) ABSTRACT

Methods of treating a subterranean formation penetrated by a well bore, by providing a treatment fluid providing a treatment fluid comprising non-bridging fibers and particles comprising a degradable material,; by introducing the treatment fluid into the well bore; and by creating a plug with the treatment fluid.

### BACKGROUND

The statements in this section merely provide background information related to the present disclosure and may not constitute prior art.

Some embodiments relate to methods applied to a well bore penetrating a subterranean formation.

Hydrocarbons (oil, condensate, and gas) are typically produced from wells that are drilled into the formations containing them. For a variety of reasons, such as inherently low permeability of the reservoirs or damage to the formation caused by drilling and completion of the well, the flow of hydrocarbons into the well is undesirably low. In this case, the well is “stimulated” for example using hydraulic fracturing, chemical (usually acid) stimulation, or a combination of the two (called acid fracturing or fracture acidizing).

Hydraulic and acid fracturing of horizontal wells as well as multi-layered formations frequently requires using diverting techniques in order to enable fracturing redirection between different zones. The list of these diverting methods includes, but is not limited to, using mechanical isolation devices such as packers and well bore plugs, setting bridge plugs, pumping ball sealers, pumping slurried benzoic acid flakes and removable/degradable particulates. As well, other treatments may require use of diverting techniques.

Treatment diversion with particulates is typically based on bridging of particles of the diverting material behind casing and forming a plug by accumulating the rest of the particles at the formed bridge. Several typical problems related to diversion treatments with particulate materials are: reducing bridging ability of diverting slurry during pumping because of dilution with well bore fluid (interface mixing), necessity of using relatively large amount of diverting materials, and poor stability of some diverting agents during pumping and during subsequent treatment stages.

Diversion involving degradable particles has become popular in the industry since it enables better control of the producing fractures and thus improved hydrocarbon recovery. A constant challenge face by the industry is the reduction of settling in the carrier fluid in order to have a homogeneous fluid downhole. To address this fibers have sometimes been used; however, they present their own challenges such a plugging the equipments or even bridging zones to be stimulated. Improvements in this area would certainly be welcome.

### SUMMARY

In aspects, methods of treating a subterranean formation penetrated by a well bore are disclosed. The methods provide a treatment fluid including particles and non-bridging fibers.

In aspects the treatment fluid comprises a blend, the blend including non-bridging fibers a first amount of particles having a first average particle size between about 3 mm and 2 cm and a second amount of particles having a second average size between about 1.6 and 20 times smaller than the first average particle size or a second amount of flakes having a second average size up to 10 times smaller than the first average particle size; introducing the treatment fluid into the well bore; and creating a plug with the treatment fluid. Also in another embodiment, the second average size is between about 2 and 10 times smaller than the first average particle size.

In further aspects, methods of treating a subterranean formation penetrated by a well bore are disclosed. The well bore may contain a casing and at least one hole in the casing, the hole having a diameter. The methods provide a treatment fluid including non-bridging fibers and particles comprising a degradable material. Said particles may be part of a blend which contains non-bridging and has a first amount of particles having a first average particle size between about 50 to 100% of the diameter and a second amount of particles having a second average size between about 1.6 and 20 times smaller than the first average particle size or a second amount of flakes having a second average size up to 10 times smaller than the first average particle size; introducing the treatment fluid into the hole; creating a plug with said treatment fluid behind casing in the vicinity to the hole or in the hole; and removing the plug. Also, in embodiments, the second average size is between about 2 and 10 times smaller than the first average particle size.

In yet further aspects, methods of fracturing a subterranean formation penetrated by a well bore are disclosed. The well bore contains a casing and at least one hole on said casing, the hole having a diameter. The methods provide a diverting fluid including non-bridging fibers and particles comprising a degradable material. The non-homogeneous particles may be part of a blend having a first amount of particles with a first average particle size between about 50 to 100% of said diameter and a second amount of particles having a second average size between about 1.6 and 20 times smaller than the first average particle size or a second amount of flakes having a second average size up to 10 times smaller than the first average particle size; introducing the diverting fluid into the hole; creating a diverting plug utilizing the diverting fluid behind casing in the vicinity to the hole or in the hole; fracturing the subterranean formation; and removing the diverting plug. Also in embodiments, the second average size is between about 2 and 10 times smaller than the first average particle size.

### BRIEF DESCRIPTION OF THE DRAWINGS

FIG. 1A schematically illustrates a bridging test apparatus according to embodiments.

FIG. 1B schematically illustrates an enlarged detail of the slot design in the apparatus of FIG. 1A.

### DETAILED DESCRIPTION

At the outset, it should be noted that in the development of any actual embodiments, numerous implementation-specific decisions must be made to achieve the developer's specific goals, such as compliance with system and business related constraints, which can vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating some embodiments and should not be construed as a limitation to the scope and applicability. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range disclosed and enabled the entire range and all points within the range.

The following definitions are provided in order to aid those skilled in the art in understanding the detailed description.

The term “treatment”, or “treating”, refers to any subterranean operation that uses a fluid in conjunction with a desired function and/or for a desired purpose. The term “treatment”, or “treating”, does not imply any particular action by the fluid.

The term “fracturing” refers to the process and methods of breaking down a geological formation and creating a fracture, i.e. the rock formation around a well bore, by pumping fluid at very high pressures (pressure above the determined closure pressure of the formation), in order to increase production rates from a hydrocarbon reservoir. The fracturing methods otherwise use conventional techniques known in the art.

The term “particulate” or “particle” refers to a solid 3D object with maximal dimension significantly less than 1 meter. Here “dimension” of the object refers to the distance between two arbitrary parallel planes, each plane touching the surface of the object at at least one point. The maximal dimension refers to the biggest distance existing for the object between any two parallel planes and the minimal dimension refers to the smallest distance existing for the object between any two parallel planes. In some embodiments, the particulates used are with a ratio between the maximal and the minimal dimensions (particle aspect ratio x/y) of less than 5 or even of less than 3.

The term “flake” refers to special type of particulate as defined above. The flake is a solid 3D object having a thickness smaller than its other dimensions, for example its length and width. Flake aspect ratios (diameter/thickness, length/thickness, width/thickness, etc . . . ) may be in the range of from about 5 to about 50 or more. For the flake, inventors define the flake aspect ratio as the ratio of the length or width to the thickness. Any suitable ratio of length to width may be used.

For the purposes of the disclosure, particles and flakes may be non-homogeneous which shall be understood in the context of the present disclosure as made of at least a continuous phase of degradable material containing a discontinuous phase. Non-homogeneous in the present disclosure also encompasses composite materials also sometimes referred to as compounded material. The non-homogeneous particles or flakes may be supplemented in the fluid with further homogeneous structure.

The term “particle size”, “particulate size” or “flake size” refers to the diameter (D) of the smallest imaginary circumscribed sphere which includes such particulate or flake.

The term “average size” refers to an average size of solids in a group of solids of each type. In each group j of particles or flakes average size can be calculated as mass-weighted value

$${\overline{L}}_{j} = \frac{{\sum }_{i = 1}^{N} {l}_{i} {m}_{i}}{{\sum }_{i = 1}^{N} {m}_{i}}$$

Where N—number of particles or flakes in the group, lᵢ, (i=1 . . . N)—sizes of individual particles or flakes; mᵢ (i=1 . . . N)—masses of individual particles or flakes.

The term “hole” refers to a 2D object of any geometry defined only by its perimeter. The term “hole diameter” or “hole size” refers to the diameter of the biggest imaginary circle which is included in such hole.

The determination of the optimal particles size in the blend may be made as described in US patent Application No 2012-0285692 incorporated herein by reference in its entirety.

While the embodiments described herewith refer to well treatment it is equally applicable to any well operations where zonal isolation is required such as drilling operations, workover operations etc.

A method of treatment for diversion or for temporally zonal isolation is disclosed. The method uses a composition made of blends of non-bridging fibers and particles or blends of particles and flakes. According to an embodiment, the size of the largest particles or flakes in the blends is slightly smaller than the diameter of perforation holes in the zone to isolate or divert. According to a further embodiment, the size of the particles or flakes in the blends is larger than an average width of the void intended to be closed or temporally isolated. The average width of the void is the smallest width of the void after the perforation hole or another entry in such void, at 10 cm, at 20 cm, at 30 cm or at 50 cm or at 500 cm (when going into the formation from the well bore). Such void may be a perforation tunnel, hydraulic fracture or wormhole. Introducing such blends composition into perforation holes results in jamming largest particles in the voids in the proximity of the well bore. Thereafter there is an accumulation of other particles on the formed bridge. In one embodiment, the ratio between particles and flakes in the blends are designed to reduce permeability of the formed plugs.

According aspect, the blends composition enables zonal isolation by creating plugs in the proximity to well bore. In comparison to traditional treatment diversion techniques, the blends composition requires lower amount of diverting material. As well, the following benefits exist: lower risk of well bore plugging, lower risk of formation damage, and better clean up. In the example where the diverting blend is designed for sealing perforation tunnels (e.g. slick-water treatments) the amount of diverting material required for treatment diversion between several perforation clusters may be as low as several kilograms. Further removal of the diverting material is achieved either by self-degradation at downhole conditions or by introducing special chemical agents or by well bore intervention.

The composition is made of non-bridging fibers and blends of particles or blends of particles and flakes in a carrier fluid. The carrier fluid may be water: fresh water, produced water, seawater. Other non-limiting examples of carrier fluids include hydratable gels (e.g. guars, poly-saccharides, xanthan, hydroxy-ethyl-cellulose, etc.), a cross-linked hydratable gel, a viscosified acid (e.g. gel-based), an emulsified acid (e.g. oil outer phase), an energized fluid (e.g. an N₂ or CO₂ based foam), and an oil-based fluid including a gelled, foamed, or otherwise viscosified oil. Additionally, the carrier fluid may be a brine, and/or may include a brine. The carrier fluid may include hydrochloric acid, hydrofluoric acid, ammonium bifluoride, formic acid, acetic acid, lactic acid, glycolic acid, maleic acid, tartaric acid, sulfamic acid, malic acid, citric acid, methyl-sulfamic acid, chloro-acetic acid, an amino-poly-carboxylic acid, 3-hydroxypropionic acid, a poly-amino-poly-carboxylic acid, and/or a salt of any acid. In certain embodiments, the carrier fluid includes a poly-amino-poly-carboxylic acid, and is a trisodium hydroxyl-ethyl-ethylene-diamine triacetate, mono-ammonium salts of hydroxyl-ethyl-ethylene-diamine triacetate, and/or mono-sodium salts of hydroxyl-ethyl-ethylene-diamine tetra-acetate.

The particle(s) or the flake(s) can be embodied as proppant. Proppant selection involves many compromises imposed by economical and practical considerations. Such proppants can be natural or synthetic (including but not limited to glass beads, ceramic beads, sand, and bauxite), coated, or contain chemicals; more than one can be used sequentially or in mixtures of different sizes or different materials. The proppant may be resin coated (curable), or pre-cured resin coated. Proppants and gravels in the same or different wells or treatments can be the same material and/or the same size as one another and the term proppant is intended to include gravel in this disclosure. In some embodiments, irregular shaped particles may be used. International application WO 2009/088317 discloses a method of fracturing with a slurry of proppant containing from 1 to 100 percent of stiff, low elasticity, low deformability elongated particles. US patent application 2008/0000638 discloses proppant that is in the form of generally rigid, elastic plate-like particles having a maximum to minimum dimension ratio of more than about 5, the proppant being at least one of formed from a corrosion resistant material or having a corrosion resistant material formed thereon. Each of the above are herein incorporated by reference.

As mentioned earlier the particulates or the blends may contain non-homogeneous particulates made of at least a degradable material and a further material.

Non-limiting examples of degradable materials that may be used include certain polymer materials that are capable of generating acids upon degradation. These polymer materials may herein be referred to as “polymeric acid precursors.” These materials are typically solids at room temperature. The polymeric acid precursor materials include the polymers and oligomers that hydrolyze or degrade in certain chemical environments under known and controllable conditions of temperature, time and pH to release organic acid molecules that may be referred to as “monomeric organic acids.” As used herein, the expression “monomeric organic acid” or “monomeric acid” may also include dimeric acid or acid with a small number of linked monomer units that function similarly to monomer acids composed of only one monomer unit.

Polymer materials may include those polyesters obtained by polymerization of hydroxycarboxylic acids, such as the aliphatic polyester of lactic acid, referred to as polylactic acid; glycolic acid, referred to as polyglycolic acid; 3-hydroxbutyric acid, referred to as polyhydroxybutyrate; 2-hydroxyvaleric acid, referred to as polyhydroxyvalerate; epsilon caprolactone, referred to as polyepsilon caprolactone or polyprolactone; the polyesters obtained by esterification of hydroxyl aminoacids such as serine, threonine and tyrosine; and the copolymers obtained by mixtures of the monomers listed above. A general structure for the above-described homopolyesters is:

H—{O—[C(R1,R2)]ₓ-[C(R3,R4)]_{y}-C═O}_{z}—OH

where,
R1, R2, R3, R4 is either H, linear alkyl, such as CH₃, CH₂CH₃ (CH₂)—CH₃, branched alkyl, aryl, alkylaryl, a functional alkyl group (bearing carboxylic acid groups, amino groups, hydroxyl groups, thiol groups, or others) or a functional aryl group (bearing carboxylic acid groups, amino groups, hydroxyl groups, thiol groups, or others);
x is an integer between 1 and 11;
y is an integer between 0 and 10; and
z is an integer between 2 and 50,000.

In the appropriate conditions (pH, temperature, water content) polyesters like those described herein can hydrolyze and degrade to yield hydroxycarboxylic acid and compounds that pertain to those acids referred to in the foregoing as “monomeric acids.”

One example of a suitable polymeric acid precursor, as mentioned above, is the polymer of lactic acid, sometimes called polylactic acid, “PLA,” polylactate or polylactide. Lactic acid is a chiral molecule and has two optical isomers. These are D-lactic acid and L-lactic acid. The poly(L-lactic acid) and poly(D-lactic acid) forms are generally crystalline in nature. Polymerization of a mixture of the L- and D-lactic acids to poly(DL-lactic acid) results in a polymer that is more amorphous in nature. The polymers described herein are essentially linear. The degree of polymerization of the linear polylactic acid can vary from a few units (2-10 units) (oligomers) to several thousands (e.g. 2000-5000). Cyclic structures may also be used. The degree of polymerization of these cyclic structures may be smaller than that of the linear polymers. These cyclic structures may include cyclic dimers.

Another example is the polymer of glycolic acid (hydroxyacetic acid), also known as polyglycolic acid (“PGA”), or polyglycolide. Other materials suitable as polymeric acid precursors are all those polymers of glycolic acid with itself or other hydroxy-acid-containing moieties, as described in U.S. Pat. Nos. 4,848,467; 4,957,165; and 4,986,355, which are herein incorporated by reference.

The polylactic acid and polyglycolic acid may each be used as homopolymers, which may contain less than about 0.1% by weight of other comonomers. As used with reference to polylactic acid, “homopolymer(s)” is meant to include polymers of D-lactic acid, L-lactic acid and/or mixtures or copolymers of pure D-lactic acid and pure L-lactic acid. Additionally, random copolymers of lactic acid and glycolic acid and block copolymers of polylactic acid and polyglycolic acid may be used. Combinations of the described homopolymers and/or the above-described copolymers may also be used.

Other examples of polyesters of hydroxycarboxylic acids that may be used as polymeric acid precursors are the polymers of hydroxyvaleric acid (polyhydroxyvalerate), hydroxybutyric acid (polyhydroxybutyrate) and their copolymers with other hydroxycarboxylic acids. Polyesters resulting from the ring opening polymerization of lactones such as epsilon caprolactone (polyepsiloncaprolactone) or copolymers of hydroxyacids and lactones may also be used as polymeric acid precursors.

Polyesters obtained by esterification of other hydroxyl-containing acid-containing monomers such as hydroxyaminoacids may be used as polymeric acid precursors. Naturally occuring aminoacids are L-aminoacids. Among the 20 most common aminoacids the three that contain hydroxyl groups are L-serine, L-threonine, and L-tyrosine. These aminoacids may be polymerized to yield polyesters at the appropriate temperature and using appropriate catalysts by reaction of their alcohol and their carboxylic acid group. D-aminoacids are less common in nature, but their polymers and copolymers may also be used as polymeric acid precursors.

NatureWorks, LLC, Minnetonka, Minn., USA, produces solid cyclic lactic acid dimer called “lactide” and from it produces lactic acid polymers, or polylactates, with varying molecular weights and degrees of crystallinity, under the generic trade name NATUREWORKS™ PLA. The PLA's currently available from NatureWorks, LLC have number averaged molecular weights (Mn) of up to about 100,000 and weight averaged molecular weights (Mw) of up to about 200,000, although any polylactide (made by any process by any manufacturer) may be used. Those available from NatureWorks, LLC typically have crystalline melt temperatures of from about 120 to about 170° C., but others are obtainable. Poly(d,l-lactide) at various molecular weights is also commercially available from Bio-Invigor, Beijing and Taiwan. Bio-Invigor also supplies polyglycolic acid (also known as polyglycolide) and various copolymers of lactic acid and glycolic acid, often called “polyglactin” or poly(lactide-co-glycolide).

The extent of the crystallinity can be controlled by the manufacturing method for homopolymers and by the manufacturing method and the ratio and distribution of lactide and glycolide for the copolymers. Additionally, the chirality of the lactic acid used also affects the crystallinity of the polymer. Polyglycolide can be made in a porous form. Some of the polymers dissolve very slowly in water before they hydrolyze.

Amorphous polymers may be useful in certain applications. An example of a commercially available amorphous polymer is that available as NATUREWORKS 4060D PLA, available from NatureWorks, LLC, which is a poly(DL-lactic acid) and contains approximately 12% by weight of D-lactic acid and has a number average molecular weight (Mn) of approximately 98,000 g/mol and a weight average molecular weight (Mw) of approximately 186,000 g/mol.

Other polymer materials that may be useful are the polyesters obtained by polymerization of polycarboxylic acid derivatives, such as dicarboxylic acids derivatives with polyhydroxy containing compounds, in particular dihydroxy containing compounds. Polycarboxylic acid derivatives that may be used are those dicarboxylic acids such as oxalic acid, propanedioic acid, malonic acid, fumaric acid, maleic acid, succinic acid, glutaric acid, pentanedioic acid, adipic acid, phthalic acid, isophthalic acid, terphthalic acid, aspartic acid, or glutamic acid; polycarboxylic acid derivatives such as citric acid, poly and oligo acrylic acid and methacrylic acid copolymers; dicarboxylic acid anhydrides, such as, maleic anhydride, succinic anhydride, pentanedioic acid anhydride, adipic anhydride, phthalic anhydride; dicarboxylic acid halides, primarily dicarboxylic acid chlorides, such as propanedioic acil chloride, malonyl chloride, fumaroil chloride, maleyl chloride, succinyl chloride, glutaroyl chloride, adipoil chloride, phthaloil chloride. Useful polyhydroxy containing compounds are those dihydroxy compounds such as ethylene glycol, propylene glycol, 1,4 butanediol, 1,5 pentanediol, 1,6 hexanediol, hydroquinone, resorcinol, bisphenols such as bisphenol acetone (bisphenol A) or bisphenol formaldehyde (bisphenol F); polyols such as glycerol. When both a dicarboxylic acid derivative and a dihydroxy compound are used, a linear polyester results. It is understood that when one type of dicaboxylic acid is used, and one type of dihydroxy compound is used, a linear homopolyester is obtained. When multiple types of polycarboxylic acids and/or polyhydroxy containing monomer are used copolyesters are obtained. According to the Flory Stockmayer kinetics, the “functionality” of the polycarboxylic acid monomers (number of acid groups per monomer molecule) and the “functionality” of the polyhydroxy containing monomers (number of hydroxyl groups per monomer molecule) and their respective concentrations, will determine the configuration of the polymer (linear, branched, star, slightly crosslinked or fully crosslinked). All these configurations can be hydrolyzed or “degraded” to carboxylic acid monomers, and therefore can be considered as polymeric acid precursors. As a particular case example, not willing to be comprehensive of all the possible polyester structures one can consider, but just to provide an indication of the general structure of the most simple case one can encounter, the general structure for the linear homopolyesters is:

H—{O—R1-O—C═O—R2-C═O}_{z}—OH

where,
R1 and R2 , are linear alkyl, branched alkyl, aryl, alkylaryl groups; and
z is an integer between 2 and 50,000.

Other examples of suitable polymeric acid precursors are the polyesters derived from phtalic acid derivatives such as polyethylenetherephthalate (PET), polybutylentetherephthalate (PBT), polyethylenenaphthalate (PEN), and the like.

In the appropriate conditions (pH, temperature, water content) polyesters like those described herein can “hydrolyze” and “degrade” to yield polycarboxylic acids and polyhydroxy compounds, irrespective of the original polyester being synthesized from either one of the polycarboxylic acid derivatives listed above. The polycarboxylic acid compounds the polymer degradation process will yield are also considered monomeric acids.

Other examples of polymer materials that may be used are those obtained by the polymerization of sulfonic acid derivatives with polyhydroxy compounds, such as polysulphones or phosphoric acid derivatives with polyhydroxy compounds, such as polyphosphates.

Such solid polymeric acid precursor material may be capable of undergoing an irreversible breakdown into fundamental acid products downhole. As referred to herein, the term “irreversible” will be understood to mean that the solid polymeric acid precursor material, once broken downhole, should not reconstitute while downhole, e.g., the material should break down in situ but should not reconstitute in situ. The term “break down” refers to both the two relatively extreme cases of hydrolytic degradation that the solid polymeric acid precursor material may undergo, e.g., bulk erosion and surface erosion, and any stage of degradation in between these two. This degradation can be a result of, inter alia, a chemical reaction. The rate at which the chemical reaction takes place may depend on, inter alia, the chemicals added, temperature and time. The breakdown of solid polymeric acid precursor materials may or may not depend, at least in part, on its structure. For instance, the presence of hydrolyzable and/or oxidizable linkages in the backbone often yields a material that will break down as described herein. The rates at which such polymers break down are dependent on factors such as, but not limited to, the type of repetitive unit, composition, sequence, length, molecular geometry, molecular weight, morphology (e.g., crystallinity, size of spherulites, and orientation), hydrophilicity, hydrophobicity, surface area, and additives. The manner in which the polymer breaks down also may be affected by the environment to which the polymer is exposed, e.g., temperature, presence of moisture, oxygen, microorganisms, enzymes, pH, and the like.

Some suitable examples of solid polymeric acid precursor material that may be used include, but are not limited to, those described in the publication of Advances in Polymer Science, Vol. 157 entitled “Degradable Aliphatic Polyesters,” edited by A. C. Albertsson, pages 1-138. Examples of polyesters that may be used include homopolymers, random, block, graft, and star- and hyper-branched aliphatic polyesters.

Another class of suitable solid polymeric acid precursor material that may be used includes polyamides and polyimides. Such polymers may comprise hydrolyzable groups in the polymer backbone that may hydrolyze under the conditions that exist in cement slurries and in a set cement matrix. Such polymers also may generate byproducts that may become sorbed into a cement matrix. Calcium salts are a nonlimiting example of such byproducts. Non-limiting examples of suitable polyamides include proteins, polyaminoacids, nylon, and poly(caprolactam). Another class of polymers that may be suitable for use are those polymers that may contain hydrolyzable groups, not in the polymer backbone, but as pendant groups. Hydrolysis of the pendant groups may generate a water-soluble polymer and other byproducts that may become sorbed into the cement composition. A nonlimiting example of such a polymer includes polyvinylacetate, which upon hydrolysis forms water-soluble polyvinylalcohol and acetate salts.

In embodiments, the compositions comprise non-homogeneous particles; in this configuration, the degradable may be compounded with at least a second material. Said second material may be for example a stabilizer. Without wishing to be bound by any theory, it is believed that, for example, polyester polymers contain ester bonds which are susceptible to hydrolysis at elevated temperatures in the presence of moisture. The hydrolysis reaction leads to molecular chain scission at the ester bond. As the polymer chains shorten, the molecular weight decreases such that the melt viscosity and intrinsic viscosity also drop. The concentration of carboxyl end groups also increases. The hydrolysis reaction rate begins to become significant at temperatures above 160° C. (320° F.). However, some subterranean formations are at much higher temperature making them practically impossible to be treated.

The inventors have determined that compounding degradable material with a stabilizer may enable treating such subterranean formations. In embodiments the stabilizer is a carbodiimide. Such carbodiimide may for example be obtained by heating an organic diisocyanate in the presence of a carbodiimidation catalyst (1.2). Cyclic phosphine oxides, such as 3-methyl-1-phenyl-3-phosphorene-1-oxide are suitable catalysts.

In embodiments, the stabilizer may be chosen from the groups consisting of mono, poly (Carbodiimide), oligomeric, aromatic, aliphatic, or cyclic carbodiimide compounds. A suitable stabilizer maybe N,N-dicyclohexylcarbodiimide , N-ethyl-N (3-dimethylamino) propyl Carbodiimide and its hydrochloride salt. In embodiments, the stabilizer may have a Molecular weight of from about 300 to about 10 000 g/mol, or from about 100 to 5000 g/mol, or about 3000 g/mol.

The particle(s) or the flake(s) can be embodied as material reacting with chemical agents. Some examples of materials that may be removed by reacting with other agents are carbonates including calcium and magnesium carbonates and mixtures thereof (reactive to acids and chelates); acid soluble cement (reactive to acids); polyesters including esters of lactic hydroxylcarbonic acids and copolymers thereof (can be hydrolyzed with acids and bases)

The non-homogeneous particles as described may comprise from 85 to 99.9 wt %, or 90 to 95 wt % of continuous phase (degradable material) and from 0.1 to 15 wt %, or 5 to 10 wt % of discontinuous phase (stabilizer).

The non-homogeneous particles containing a stabilizer are particularly useful for high temperature wellbore treatment. High temperature in the present context encompasses temperatures of from about 135° C. (275° F.) to 250° C. (482° F.), or 149° C. (300° F.) to about 204° C. (400° F.).

In embodiments, the compositions comprise non-homogeneous compounded particles where the degradable material may be combined with a hydrolysis catalyst.

The hydrolysis catalyst may be a light burned magnesium oxide. The non-homogeneous particles including the hydrolysis catalyst enable a controlled degradation time even at the low temperatures required sometime for downhole application. Indeed, the regular degradable treatment materials used in the industry are for temperature downhole of about 80° C. When lower temperature are present, the degradation rate of the current degradable material such as polylactic acid makes in economically not usable cause it takes to long for the particles to disappear thus enabling the operator to resume work. Combination of degradable material with metal oxides have been used; however, as demonstrated in the examples of the present application regular metal oxides do not enable a sufficiently high degradation rate at low temperature. The inventors have determined that there is a synergistic effect between degradable material and hydrolysis catalyst such a light burned magnesium oxides.

Three basic types or grades of “burned” magnesium oxide can be obtained from calcination with the differences between each grade related to the degree of reactivity remaining after being exposed to a range of extremely high temperatures. The original or “parent” magnesium hydroxide particle is usually a large and loosely bonded particle. Exposure to thermal degradation causes this particle to alter its structure so that the surface pores are slowly filled in while the particle edges become more rounded. Thermal alteration dramatically affects the reactivity of magnesium oxide since less surface area and pores are available for reaction with other compounds. It is noteworthy that although the calcination process affects the surface area of the MgO, it is, indeed, possible to obtain MgO having similar particle size but different surface area with different calcination processes. The main grades available to the industry are:
Dead burned magnesium oxide Temperatures used when calcining to produce refractory grade magnesia will range between 1500° C.-2000° C. and the magnesium oxide is referred to as “dead-burned”.
Hard burned magnesium oxide: A second type of magnesium oxide produced from calcining at temperatures ranging from 1000° C.-1500° C. is termed “hard-burned.”
Light burned magnesium oxide/Caustic magnesium oxide: The third grade of MgO is produced by calcining at temperatures ranging from 700° C.-1000° C., even 500-700 in some cases and is termed “light-burn”, light magnesia or “caustic” magnesia.

In embodiments, the hydrolysis catalyst according to the present disclosure is a light burned magnesium oxide having a surface area (BET) of from about 100 to about 210 m²/g, or from 100 to 160 m²/g or from 100 to 140 m²/g. It may be noted that light burned magnesium oxide having a high BET (i.e. above 160 m²/g) may cause operational issue cause during the compounding; its high activity may cause degradation to start. Accordingly, when using a high BET magnesium oxide, it may be desirable to passivate its catalytic activity using for example a coating or compounding the particles with a stabilizer or delaying agent. Such stabilizer maybe a carbodiimide.

The non-homogeneous particles as described may comprise from 70 to 99 wt %, or 80 to 95 wt % of continuous phase (degradable material) and from 1 to 30 wt %, or 5 to 20 wt % of discontinuous phase (hydrolysis catalyst).

The non-homogeneous particles containing a hydrolysis catalyst are particularly useful for low temperature wellbore treatment. Low temperature in the present context encompasses temperatures of from about 21° C. (70° F.) to about 93° C. (200° F.), or 37° C. (100° F.) to about 71° C. (160° F.), or from about 37° C. (100° F.) to about 60° C. (140° F.).

In all embodiments, the compounded non-homogeneous material may be obtained by coextrusion of a mixture of polylactic resin containing the suitable quantity of discontinuous phase. The mixture is co-extruded to form the compounded material. Said compounded material may be beads, rods, particles, flakes or fibers and mixtures thereof.

The particle(s) or the flake(s) can be embodied as melting material. Examples of meltable materials that can be melted at downhole conditions hydrocarbons with number of carbon atoms>30; polycaprolactones; paraffin and waxes; carboxylic acids such as benzoic acid and its derivatives; etc. Wax particles can be used. The particles are solid at the temperature of the injected fluid, and that fluid cools the formation sufficiently that the particles enter the formation and remain solid. Aqueous wax are commonly used in wood coatings; engineered wood processing; paper and paperboard converting; protective architectural and industrial coatings; paper coatings; rubber and plastics; inks; textiles; ceramics; and others. They are made by such companies as Hercules Incorporated, Wilmington, Del., U.S.A., under the trade name PARACOL®, Michelman, Cincinnati, Ohio, U.S.A., under the trade name MICHEM®, and ChemCor, Chester, N.Y., U.S.A. Particularly suitable waxes include those commonly used in commercial car washes. In addition to paraffin waxes, other waxes, such as polyethylenes and polypropylenes, may also be used.

The particle(s) or the flake(s) can be embodied as water-soluble material or hydrocarbon-soluble material. The list of the materials that can be used for dissolving in water includes water-soluble polymers, water-soluble elastomers, carbonic acids, rock salt, amines, inorganic salts). List of the materials that can be used for dissolving in oil includes oil-soluble polymers, oil-soluble resins, oil-soluble elastomers, polyethylene, carbonic acids, amines, waxes).

The particle(s) and the flake(s) size are chosen so the size of the largest particles or flakes is slightly smaller than the diameter of the perforation holes in casing and larger than the average width of the voids behind casing (perforation tunnels, fractures or wormholes). By perforation hole, we mean any type of hole present in the casing. This hole can be a perforation, a jetted hole, hole from a slotted liner, port or any opening in a completion tool, casing fluid exit point. According to a further embodiment, the size of particles or flakes in the blend is designed for reducing permeability of the plugs in the narrow voids behind casing (perforation tunnels, fractures or wormholes). In general the particle or flake used will have an average particle size of less than several centimeters, preferably less than 2 cm, and more preferably less than 1 cm. In one embodiment, some particle or flake will have an average particle size of from about 0.04 mm to about 4.76 mm (about 325 to about 4 U.S. mesh), preferably from about 0.10 mm to about 4.76 mm (about 140 to about 4 U.S. mesh), more preferably from about 0.15 mm to about 3.36 mm (about 100 to about 6 U.S. mesh) or from about 2 mm to about 12 mm.

According to a further embodiment, the particles blend or the particles/flakes blend composition contains particles or flakes with different particles/flakes size distribution. In one embodiment, the composition comprises particulate materials with defined particles size distribution. On example of realization is disclosed in U.S. Pat. No. 7,784,541, herewith incorporated by reference in its entirety.

In certain embodiments, the selection of the size for the first amount of particulates is dependent upon the characteristics of the perforated hole as described above: the size of the largest particles or flakes is slightly smaller than the diameter of the perforation holes in casing. In certain further embodiments, the selection of the size of the first amount of particulates is dependent upon the void behind casing: the size of the particles is larger than the average width of the voids behind casing (perforation tunnels, fractures or wormholes). In certain further embodiments, the selection of the size for the first amount of particulates is dependent upon the characteristics of the perforated hole and the void behind casing: the size of the largest particles or flakes is slightly smaller than the diameter of the perforation holes in casing and larger than the average width of the voids behind casing (perforation tunnels, fractures or wormholes). In certain further embodiments, the selection of the size for the first amount of particulates is dependent upon the characteristics of the desired fluid loss characteristics of the first amount of particulates as a fluid loss agent, the size of pores in the formation, and/or the commercially available sizes of particulates of the type comprising the first amount of particulates. The first average particle size is between about 100 micrometers and 2 cm, or between about 100 micrometers and 1 cm or between about 400 micrometers and 1000 micrometers, or between about 3000 micrometers and 10000 micrometers, or between about 6 millimeters and 10 millimeters, or between about 6 millimeters and 8 millimeters. Also in some embodiments, the same chemistry can be used for the first average particle size. Also in some embodiments, different chemistry can be used for the same first average particle size: e.g. in the first average particle size, half of the amount is proppant and the other half is resin coated proppant.

In certain embodiments, the selection of the size for the second amount of particulates is dependent upon the characteristics of the desired fluid loss characteristics of the second amount of particulates as a fluid loss agent, the size of pores in the formation, and/or the commercially available sizes of particulates of the type comprising the second amount of particulates.

In certain embodiments, the selection of the size of the second amount of particulates is dependent upon maximizing or optimizing a packed volume fraction (PVF) of the mixture of the first amount of particulates and the second amount of particulates. The packed volume fraction or packing volume fraction (PVF) is the fraction of solid content volume to the total volume content. The particles size distribution required for maximizing PVF in narrow slot may be different from the particles size distribution required for maximizing PVF in a continuum system. Therefore, in certain embodiments, the selection of the size of the second amount of particulates is dependent upon maximizing or optimizing a packed volume fraction (PVF) of the mixture of the first amount of particulates and the second amount of particulates in narrow voids between 2 mm and 2 cm. In certain embodiments, the selection of the size of the second amount of particulates is dependent upon maximizing or optimizing a packed volume fraction (PVF) of the mixture of the first amount of particulates and the second amount of particulates in a fracture or slot with width of less than 20 mm. A second average particle size of between about two to ten times smaller than the first amount of particulates contributes to maximizing the PVF of the mixture or the mixture placed in the void to plug, or the mixture placed in a fracture or slot with width of less than 20 mm, but a size between about three to twenty times smaller, and in certain embodiments between about three to fifteen times smaller, and in certain embodiments between about three to ten times smaller will provide a sufficient PVF for most storable compositions. Further, the selection of the size of the second amount of particulates is dependent upon the composition and commercial availability of particulates of the type comprising the second amount of particulates. In certain embodiments, the particulates combine to have a PVF above 0.74 or 0.75 or above 0.80. In certain further embodiments the particulates may have a much higher PVF approaching 0.95. In embodiments, all the different particle sizes are compounded polymer containing light burned MgO. In embodiments, only one size is compounded and the others are regular polymer. In embodiments, the largest particles only are compounded.

In certain embodiments, the selection of the size for the second amount of flakes is dependent upon the characteristics of the desired fluid loss characteristics of the second amount of flakes as a fluid loss agent, the size of pores in the formation, and/or the commercially available sizes of flakes of the type comprising the second amount of flakes. The flake size is in the range of 10-100% of the size of the first amount of particulate, more preferably 20-80% of the size of the first amount of particulate.

In certain embodiments, the selection of the size of the second amount of flakes is dependent upon maximizing or optimizing a packed volume fraction (PVF) of the mixture of the first amount of particulates and the second amount of flakes. The packed volume fraction or packing volume fraction (PVF) is the fraction of solid content volume to the total volume content. In certain embodiments, the selection of the size of the second amount of flakes is dependent upon maximizing or optimizing a packed volume fraction (PVF) of the mixture of the first amount of particulates and the second amount of flakes in narrow voids between 3 mm and 2 cm. In certain embodiments, the selection of the size of the second amount of flakes is dependent upon maximizing or optimizing a packed volume fraction (PVF) of the mixture of the first amount of particulates and the second amount of flakes in a fracture or slot with width of less than 20 mm. In certain embodiments, PVF may not necessarily the criterion for selecting the size of flakes.

In certain further embodiments, the selection of the size for the second amount of particulates/flakes is dependent upon the characteristics of the void behind casing and upon maximizing a packed volume fraction (PVF) of the mixture of the first amount of particulates and the second amount of particulates/flakes as discussed above. Also in some embodiments, the same chemistry can be used for the second average particle/flake size. Also in some embodiments, different chemistry can be used for the same second average particle size: e.g. in the second average particle size, half of the amount is PLA and the other half is PGA.

In certain further embodiments, the composition further includes a third amount of particulates/flakes having a third average particle size that is smaller than the second average particle/flake size. In certain further embodiments, the composition may have a fourth or a fifth amount of particles/flakes. Also in some embodiments, the same chemistry can be used for the third, fourth, or fifth average particle/flake size. Also in some embodiments, different chemistry can be used for the same third average particle size: e.g. in the third average particle size, half of the amount is PLA and the other half is PGA. For the purposes of enhancing the PVF of the composition, more than three or four particles sizes will not typically be required. However, additional particles may be added for other reasons, such as the chemical composition of the additional particles, the ease of manufacturing certain materials into the same particles versus into separate particles, the commercial availability of particles having certain properties, and other reasons understood in the art.

In certain further embodiments, the composition further comprises a viscosifying agent. The viscosifying agent may be any crosslinked polymers. The polymer viscosifier can be a metal-crosslinked polymer. Suitable polymers for making the metal-crosslinked polymer viscosifiers include, for example, polysaccharides such as substituted galactomannans, such as guar gums, high-molecular weight polysaccharides composed of mannose and galactose sugars, or guar derivatives such as hydroxypropyl guar (HPG), carboxymethylhydroxypropyl guar (CMHPG) and carboxymethyl guar (CMG), hydrophobically modified guars, guar-containing compounds, and synthetic polymers. Crosslinking agents based on boron, titanium, zirconium or aluminum complexes are typically used to increase the effective molecular weight of the polymer and make them better suited for use in high-temperature wells.

Other suitable classes of polymers effective as viscosifying agent include polyvinyl polymers, polymethacrylamides, cellulose ethers, lignosulfonates, and ammonium, alkali metal, and alkaline earth salts thereof. More specific examples of other typical water soluble polymers are acrylic acid-acrylamide copolymers, acrylic acid-methacrylamide copolymers, polyacrylamides, partially hydrolyzed polyacrylamides, partially hydrolyzed polymethacrylamides, polyvinyl alcohol, polyalkyleneoxides, other galactomannans, heteropolysaccharides obtained by the fermentation of starch-derived sugar and ammonium and alkali metal salts thereof.

Cellulose derivatives are used to a smaller extent, such as hydroxyethylcellulose (HEC) or hydroxypropylcellulose (HPC), carboxymethylhydroxyethylcellulose (CMHEC) and carboxymethycellulose (CMC), with or without crosslinkers. Xanthan, diutan, and scleroglucan, three biopolymers, have been shown to have excellent particulate-suspension ability even though they are more expensive than guar derivatives and therefore have been used less frequently, unless they can be used at lower concentrations.

In other embodiments, the viscosifying agent is made from a crosslinkable, hydratable polymer and a delayed crosslinking agent, wherein the crosslinking agent comprises a complex comprising a metal and a first ligand selected from the group consisting of amino acids, phosphono acids, and salts or derivatives thereof. Also the crosslinked polymer can be made from a polymer comprising pendant ionic moieties, a surfactant comprising oppositely charged moieties, a clay stabilizer, a borate source, and a metal crosslinker. Said embodiments are described in U.S. Patent Publications US2008-0280790 and US2008-0280788 respectively, each of which are incorporated herein by reference.

The viscosifying agent may be a viscoelastic surfactant (VES). The VES may be selected from the group consisting of cationic, anionic, zwitterionic, amphoteric, nonionic and combinations thereof. Some non-limiting examples are those cited in U.S. Pat. Nos. 6,435,277 (Qu et al.) and 6,703,352 (Dahayanake et al.), each of which are incorporated herein by reference. The viscoelastic surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of VES suitable to achieve the desired viscosity. The viscosity of VES fluids may be attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscous and elastic behavior.

In general, particularly suitable zwitterionic surfactants have the formula:

RCONH—(CH₂)ₐ(CH₂CH₂O)ₘ(CH₂)_{b}—N⁺(CH₃)₂(CH₂)_{a′}(CH₂CH₂O)_{m′}(CH₂)_{b′}COO⁻

in which R is an alkyl group that contains from about 11 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to 10 if m is 0; a′ and b′ are each 1 or 2 when m′ is not 0 and (a′+b′) is from 1 to 5 if m is 0; (m+m′) is from 0 to 14; and CH₂CH₂O may also be OCH₂CH₂. In some embodiments, a zwitterionic surfactants of the family of betaine is used.

Exemplary cationic viscoelastic surfactants include the amine salts and quaternary amine salts disclosed in U.S. Pat. Nos. 5,979,557, and 6,435,277 which are hereby incorporated by reference. Examples of suitable cationic viscoelastic surfactants include cationic surfactants having the structure:

R₁N⁺(R₂)(R₃)(R₄) X⁻

in which R₁ has from about 14 to about 26 carbon atoms and may be branched or straight chained, aromatic, saturated or unsaturated, and may contain a carbonyl, an amide, a retroamide, an imide, a urea, or an amine; R₂ , R₃, and R₄ are each independently hydrogen or a C₁ to about C₆ aliphatic group which may be the same or different, branched or straight chained, saturated or unsaturated and one or more than one of which may be substituted with a group that renders the R₂, R₃, and R₄ group more hydrophilic; the R₂, R₃ and R₄ groups may be incorporated into a heterocyclic 5- or 6-member ring structure which includes the nitrogen atom; the R₂, R₃ and R₄ groups may be the same or different; R₁, R₂, R₃ and/or R₄ may contain one or more ethylene oxide and/or propylene oxide units; and X⁻ is an anion. Mixtures of such compounds are also suitable. As a further example, R₁ is from about 18 to about 22 carbon atoms and may contain a carbonyl, an amide, or an amine, and R₂, R₃, and R₄ are the same as one another and contain from 1 to about 3 carbon atoms.

Amphoteric viscoelastic surfactants are also suitable. Exemplary amphoteric viscoelastic surfactant systems include those described in U.S. Pat. No. 6,703,352, for example amine oxides. Other exemplary viscoelastic surfactant systems include those described in U.S. Pat. Nos. 6,239,183; 6,506,710; 7,060,661; 7,303,018; and 7,510,009 for example amidoamine oxides. These references are hereby incorporated in their entirety. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

The viscoelastic surfactant system may also be based upon any suitable anionic surfactant. In some embodiments, the anionic surfactant is an alkyl sarcosinate. The alkyl sarcosinate can generally have any number of carbon atoms. Alkyl sarcosinates can have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula:

R₁CON(R₂)CH₂X

wherein R₁ is a hydrophobic chain having about 12 to about 24 carbon atoms, R₂ is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecentyl group, an octadecyl group, and a docosenoic group.

The compositions disclosed comprise fibers. The fibers may be straight, curved, bent or undulated. Other non-limiting shapes may include hollow, generally spherical, rectangular, polygonal, etc. Fibers or elongated particles may be used in bundles. The fibers may have a length of less than about 1 mm to about 30 mm or more.

In embodiments the fibers may have a length of 12 mm or less with a diameter or cross dimension of about 200 microns or less, with from about 10 microns to about 200 microns being typical. For elongated materials, the materials may have a ratio between any two of the three dimensions of greater than 5 to 1. In certain embodiments, the fibers or elongated materials may have a length of greater than 1 mm, with from about 1 mm to about 30 mm, from about 2 mm to about 25 mm, from about 3 mm to about 20 mm, being typical. In certain applications the fibers or elongated materials may have a length of from about 1 mm to about 10 mm (e.g. 6 mm). The fibers or elongated materials may have a diameter or cross dimension of from about 5 to 100 microns and/or a denier of about 0.1 to about 20, more particularly a denier of about 0.15 to about 6.

In some embodiments, the fiber is dispersed in the carrier fluid in an amount effective to inhibit settling of the proppant. This settling inhibition may be evidenced, in some embodiments, for example, in a static proppant settling test at 25° C. for 90 minutes. The proppant settling test in some embodiments involves placing the fluid in a container such as a graduated cylinder and recording the upper level of dispersed proppant in the fluid. The upper level of dispersed proppant is recorded at periodic time intervals while maintaining settling conditions. The proppant settling fraction is calculated as:

$$Proppant settling = \frac{\begin{matrix}[ initial proppant level ( t = 0 ) ] - \\ [ upper proppant level at time n ]\end{matrix}}{[ initial proppant level ( t = 0 ) ] - [ final proppant level ( t = ∞ ) ]}$$

The fiber inhibits proppant settling if the proppant settling fraction for the fluid containing the proppant and fiber has a lower proppant settling fraction than the same fluid without the fiber and with proppant only. In some embodiments, the proppant settling fraction of the treatment fluid in the static proppant settling test after 90 minutes is less than 50%, e.g., less than 40%.

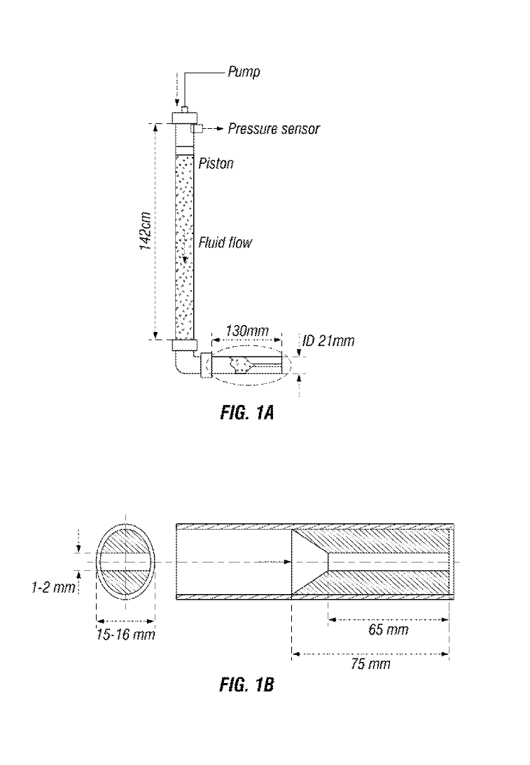

In some embodiments, the fiber is dispersed in the carrier fluid in an amount insufficient to cause bridging, e.g., as determined in a small slot test comprising passing the treatment fluid comprising the carrier fluid and the fiber without proppant at 25° C. through a bridging apparatus such as that shown in FIGS. 1A and 1B comprising a 1.0-2.0 mm slot that is 15-16 mm wide and 65 mm long at a flow rate equal to 15 cm/s, or at a flow rate equal to 10 cm/s.

In some embodiments the fiber is dispersed in the carrier fluid in both an amount effective to inhibit settling of the proppant and in an amount insufficient to cause bridging, wherein settling and bridging are determined by comparing proppant accumulation in a narrow fracture flow test comprising pumping the treatment fluid at 25° C. through a 1-2 mm slot measuring 3 m long by 0.5 m high for 60 seconds at a flow velocity of 30 cm/s, or at a flow velocity of 15 cm/s, relative to a reference fluid containing the carrier fluid and proppant only without the fiber. In the narrow fracture flow test, the slot may be formed of flow cells with transparent windows to observe proppant settling at the bottom of the cells. Proppant settling is inhibited if testing of the fluid with the proppant and fiber results in measurably less proppant settling than the same fluid and proppant mixture without the fiber at the same testing conditions. Bridging is likewise observed in the narrow fracture flow test as regions exhibiting a reduction of fluid flow also resulting in proppant accumulation in the flow cells.

In some embodiments, the treatment fluid comprises from 1.2 to 12 g/L of the fibers based on the total volume of the carrier fluid (from 10 to 100 ppt, pounds per thousand gallons of carrier fluid), e.g., less than 4.8 g/L of the fibers based on the total volume of the carrier fluid (less than 40 ppt) or from 1.2 or 2.4 to 4.8 g/L of the fibers based on the total volume of the carrier fluid (from 10 or 20 to 40 ppt).

In some embodiments, the fibers are crimped staple fibers. In some embodiments, the crimped fibers comprise from 1 to 10 crimps/cm of length, a crimp angle from 45 to 160 degrees, an average extended length of fiber of from 4 to 15 mm, and/or a mean diameter of from 8 to 40 microns, or 8 to 12, or 8 to 10, or a combination thereof. In some embodiments, the fibers comprise low crimping equal to or less than 5 crimps/cm of fiber length, e.g., 1-5 crimps/cm.

Depending on the temperature that the treatment fluid will encounter, especially at downhole conditions, the fibers may be chosen depending on their resistance or degradability at the envisaged temperature. In the present disclosure, the terms “low temperature fibers”, “mid temperature fibers” and “high temperature fibers” may be used to indicate the temperatures at which the fibers may be used for delayed degradation, e.g., by hydrolysis, at downhole conditions.

In some embodiments, the fibers comprise polyester. In some embodiments, the polyester undergoes hydrolysis at a low temperature of less than about 93° C. as determined by slowly heating 10 g of the fibers in 1 L deionized water until the pH of the water is less than 3, and in some embodiments, the polyester undergoes hydrolysis at a moderate temperature of between about 93° C. and 149° C. as determined by slowly heating 10 g of the fibers in 1 L deionized water until the pH of the water is less than 3, and in some embodiments, the polyester undergoes hydrolysis at a high temperature greater than 149° C., e.g., between about 149.5° C. and 204° C. In some embodiments, the polyester is selected from the group consisting of polylactic acid, polyglycolic acid, copolymers of lactic and glycolic acid, and combinations thereof.

In some embodiments, the fiber is selected from the group consisting of polylactic acid (PLA), polyglycolic acid (PGA), polyethylene terephthalate (PET), polyester, polyamide, polycaprolactam and polylactone, poly(butylene) succinate, polydioxanone, nylon, glass, ceramics, carbon (including carbon-based compounds), elements in metallic form, metal alloys, wool, basalt, acrylic, polyethylene, polypropylene, novoloid resin, polyphenylene sulfide, polyvinyl chloride, polyvinylidene chloride, polyurethane, polyvinyl alcohol, polybenzimidazole, polyhydroquinone-diimidazopyridine, poly(p-phenylene-2,6-benzobisoxazole), rayon, cotton, cellulose and other natural fibers, rubber, and combinations thereof.

Any type of PLA might be used. In embodiments, when PLA is used, said PLA may be poly-D, poly-L or poly-D, L lactic acid, or stereocomplex polylactic (sc-PLA) and mixtures thereof. In embodiment the PLA may have a molecular weight (Mw) of from about 750 g/mol to about 5,000,000 g/mol, or from 5000 g/mol to 1 000 000 g/mol, or from 10,000 g/mol to 500,000 g/mol, or from 30,000 g/mol to 500 000 g/mol. The polydispersity of these polymers might be between 1.5 to 5.

The inherent viscosity of PLA that may be used, as measured in Hexafluoro-2-propanol at 30 deg C., with 0.1% polymer concentration may be from about 1.0 dl/g to 2.6 about dl/g, or from 1.3 dl/g to 2.3 dl/g.

In embodiments, the PLA may have a glass transition temperature (Tg) above about 20° C., or above 25° C., or above 30° C., or from 35° C. to 55° C. In embodiments, the PLA may have a melting temperature (Tm) below about 140° C., or about 160° C., or about 180° C. or from about 220° C. to about 230° C.

In some embodiments, the fibers contain silicones. Without wishing to be bound by any theory, it is believe that fibers containing 0.1 to 20 wt %, or 0.1 to 5% of silicones exhibit a higher dispersibility while also having a higher non-bridging capacity.

In embodiments, the fiber, comprising a polyester and silicones may be in the form of a dual component with a shell and a core. In this configuration at least the shell or the core contain a polyester and one of the component or both contain 0.1 to 20 wt % of silicones. The two components may have different degradation rate depending on the conditions.

The silicone may be present in the fiber in 0.1 to 20 wt %, or 0.1 to 5 wt %, or 0.1 to 3 wt %. or 0.5 to 3wt %. The fiber containing silicones in the present context shall be understood as polymeric fibers, such a polyester, containing a dispersed phase of silicones. This type of fibers may be obtained for example by mixing melting silicones and melted polymers and then extruding the mixture so that the repartition of silicones may be relatively homogeneous. In embodiments the fibers may be obtained by extrusion from pellets of thermoplastic material containing silicones and PLA.

Silicones in the present context may be understood broadly. The silicones as used in the disclosure are solid at room temperature (25° C.). As mentioned previously, the polymer part and the silicones part may typically be mixed as solid at room temperature before melt so that a homogeneous distribution can be obtained throughout the polymer fiber. In embodiments, the silicone is obtained from silicate, for example silica, or fumed silica; when fumed silica is used, it may have a specific surface area (BET) above about 30 m²/g, or above 50m²/g. In embodiments, the silicone used is prepared from polymer containing siloxane and organic radicals.

The silicone polymers may be cyclic polysiloxanes, linear polysiloxanes, branched polysiloxanes, crosslinked polysiloxanes and mixtures thereof.

Linear polysiloxanes that may be used are the ones of the formula:

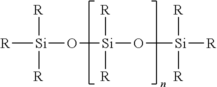

Wherein R may be C1-C10 hydrocarbon radical, or alkyl, aryl, etc.

In embodiments cyclic polysiloxanes of the following formula may be used:

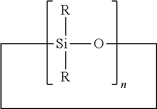

Wherein R may be C1-C10 hydrocarbon radical, or alkyl, aryl, etc. n may be an integer of at least 4, 5 or 6.

In embodiments, branched polysiloxane of the following formula may be used:

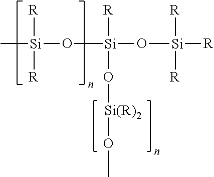

Wherein R may be C1-C10 hydrocarbon radical, or alkyl, aryl, etc.
n may be the same or different and for a number from 10 to 10,000.

In embodiments, cross-linked polysiloxanes of the following formula may be used:

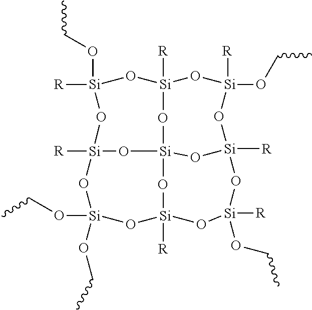

Wherein R may be C1-C10 hydrocarbon radical, or alkyl, aryl, etc.

In embodiments, the silicone used is a linear silicone. In embodiment, such linear silicone has a molecular weight (Mw) of at least about 100,000 g/mol, or at least 150,000 g/mol, or at least 200,000 g/mol and up to about 900,000 g/mol, or up to 700,000 g/mol, or up to 650,000 g/mol, or up to 600,000 g/mol. In embodiments, the high molecular weight, non-crosslinked, linear silicone polymers used may have, at 25° C., a density between 0.76 and 1.07 g/cm³, or from 0.9 to 1.07 g/cm³, or from 0.95 to 1.07 g/cm³.

The fibers containing silicone provide better particles transport and reduced settling with reduced water requirements (higher particles loading), reduced particles requirements (better particles placement) and reduced power requirements (lower fluid viscosity and less pressure drop). The fibers may increase particles transport in a low viscosity fluid. The fibers may be degradable after placement in the formation. The fibers may also by non-homogeneous for examples made a of composite of degradable material and stabilizer or degradable material and hydrolysis catalyst or both.

Fibers enable keeping diversion particulates from dispersing so that the particles reach the downhole target zone in a homogeneous concentration, this, without fibers is extremely difficult especially at high loading, for example about 20 lbs/1000 gal. Fibers may be added in a spacer before the addition of the particles in the stream, during the addition of particles or in the flush after the particles. Spacer, pill and flush may be made from a linear gel with a viscosifying agent such as guar.

In this type of linear gels, fibers have the tendency to bridge over orifices and downhole features (such as a fracture). This tendency is particularly observed on formation with very narrow fractures where fibers tend to bridge over fracture walls. This has the potential to negatively affect the objective and/or the quality of the diversion treatment. If the portion of the fibers ahead of the diverting particles bridges over the fracture which takes fluid, then the remaining portion of the diverting pill-including the particles will be diverted to another region in the wellbore. In some instance said other region may even be the region expected to be stimulated further. The diverting particles would then prematurely plug the region and preventing further fluid from stimulating that region.

A further problem that may be encountered is when the portion of the fibers following the diverting particles bridge over an opened fracture. Indeed, this would also have the effect of redirecting further fluid into another location than the target zone.

Further, the present disclosure describes an efficient way for determining efficient particles concentration; it is, however, difficult to determine the amount of fibers required to plug a downhole feature. Indeed, fiber bridging is subject, inter alia, to fiber loading, fluid rheology, fluid rate, aperture of the heterogeneity, and rugosity of the walls of the heterogeneity to bridge over and plug. These factors are difficult, if not impossible to determine in practice. Therefore, a non-bridging fiber would enable to achieve noth a proper particle transport with avoiding the risks attached to bridging.

In some embodiments, the carrier fluid may optionally further comprise additional additives, including, but not limited to, acids, fluid loss control additives, gas, corrosion inhibitors, scale inhibitors, catalysts, clay control agents, biocides, friction reducers, combinations thereof and the like. For example, in some embodiments, it may be desired to foam the composition using a gas, such as air, nitrogen, or carbon dioxide.

The compounded material may further plasticizer, nucleation agent, flame retardant, antioxidant agent, or desiccant.

The composition may be used for carrying out a variety of subterranean treatments, including, but not limited to, drilling operations, fracturing treatments, diverting treatments, zonal isolation and completion operations (e.g., gravel packing). In some embodiments, the composition may be used in treating a portion of a subterranean formation. In certain embodiments, the composition may be introduced into a well bore that penetrates the subterranean formation as a treatment fluid. For example, the treatment fluid may be allowed to contact the subterranean formation for a period of time. In some embodiments, the treatment fluid may be allowed to contact hydrocarbons, formations fluids, and/or subsequently injected treatment fluids. After a chosen time, the treatment fluid may be recovered through the well bore.

Methods of wellsite and downhole delivery of the composition are the same as for existing particulate diverting materials. Typically such particulate materials are introduced in the pumping fluid and then displaced into the perforations at high pumping rate. The list of injecting equipment may include various dry additive systems, flow-through blenders etc. In one embodiment the blends of particles may be batch missed and then introduced into the treating fluid in slurred form. Simple flow-through injecting apparatuses may also be used. In one embodiment the composition may be delivered downhole in a bailer or in a tool comprising bailer and a perforation gun as described in US Patent Application 2008/0196896 incorporated herewith by reference. Other way of delivery of the composition can be envisioned for example with a wireline tool, a drill string, through a slickline, with a coil tubing or microcoil, with a downhole tool or any type of other device introduced downhole and able to deliver the composition at a defined location. A microcoil or Microhole Coiled Tubing Drilling Rig (MCTR) is a tool capable of performing an entire “grass-roots” operation in the 0-5000 ft true vertical depth range including drilling and casing surface, intermediate, and production and liner holes.

As soon as the volume of diverting blend required for treatment diversion is relatively low there is a risk that particles in the blend will be separated during pumping through the well bore. It may result in poorer treatment diversion because of forming plugs of higher permeability than expected. To avoid this situation, long slugs with low concentration of diverting blends may be introduced in the treating fluid for minimizing the risk of particles separation in the main amount of the pumped blend. In one other embodiment, to avoid this situation diverting blends may be pumped in long slugs at low concentrations which will make volume of the diverting stage comparable with the volume of the well bore. For example for wells with well bore volume of 200 bbl (32 m³) the volumes of the diverting stage that minimizes the risk of particles separation may be in the range of 20-100 bbl (3.2-16 m³). For 5-25 kg of diverting material it corresponds to the range of concentrations of 0.3-8 kg/m³.

Creating plugs of the proposed diverting blends happens by accumulating particles in the void space behind casing. Examples of such voids may be perforation tunnels, hydraulic fractures or wormholes. Plug creation consists of two steps. In the first step some largest particles in the diverting blend jam in the void creating a bridge. During the next step other particles are being accumulated at the formed bridge resulting in plug formation.

After treatment, the created plugs are removed. There are several methods that may be applied for removal of the created plugs. If the composition comprises degradable materials, self-degradation will occur. If the composition comprises material reacting with chemical agents, those are removed by reacting with other agents. If the composition comprises melting material, melting may result in reduction in mechanical stability of the plug. If the composition comprises water soluble or hydrocarbon soluble materials. Plug removal may be achieved through physical dissolution of at least one of the components of the diverting blend in the surrounding fluid. Solubility of the mentioned components may be in significant dependence on temperature. In this situation post-treatment temperature recovery in the sealed zone may trigger the removal of the sealer. Disintegration of at least one component of the composition may occur. Plug removal may be also achieved through disintegration of the sealer into smaller pieces that will be flushed away. List of possible materials that may possess disintegration include plastics such as PLA, polyamides and composite materials comprising degradable plastics and non-degradable fine solids. It worth to mention that some of degradable material pass disintegration stage during degradation process. Example of it is PLA which turns into fragile materials before complete degradation.

To facilitate a better understanding, the following examples of embodiments are given. In no way should the following examples be read to limit, or define, the scope of the overall disclosure.

### EXAMPLES

The bridging screen test apparatus used is seen in FIGS. 1A and 1B. The fluid being tested was pumped through the apparatus at a flow rate of 10-500 mL/min for a period of at least 1 minute (at the end of the time period the total volume of fluid pumped was 500 mL). Formation of a fiber plug in the slot (1-2 mm) was indicated by a pressure rise. Bridging tests using the test apparatus of FIGS. 1A-1B were conducted without proppant unless otherwise noted. The fluid was recorded as negative for bridge formation if no plug was formed.

A narrow fracture flow test apparatus was also employed for more in depth analysis. The narrow fracture flow test apparatus employed parallel glass panes with a length of 3 m, height of 0.5 m and width of 2 mm for visualization of the fluid and proppant at a flow rate up to 50 L/min. The narrow fracture flow tests were run with L-, T- and X-shape slot orientation.

### Example 1

### Fiber Bridging in Low Viscosity Guar Fluid

In this example, a treatment fluid containing a linear guar fluid, 2.4 g/L (20 ppt) guar, at 4.8 g/L (40 ppt) of fibers NF1, CF10 and CF14 without particles was prepared.

The characteristics of the fibers were the following:
Uncrimped: Polylactic acid fibers, not crimped, diameter of 13 microns and length of 6 mm.
Crimped: Polylactic acid, crimped, diameter of 10 microns and length of 6 mm.

The bridge screening test results are presented in Table 1.

TABLE 1
Screening Bridge Testing.

| Flow rate, | Linear velocity, | | |
|---|---|---|---|
| mL/min | cm/s | uncrimped | crimped |
| 150 | 8.59 | Bridged | No Bridge |
| 200 | 11.4 | Bridged | No Bridge |
| 250 | 14.3 | Bridged | No Bridge |
| 300 | 17.2 | Bridged | No Bridge |

The foregoing data show that crimped fibers have a non-bridging capacity superior to uncrimped fibers.

### Example 2

### Fiber Bridging in Low Viscosity Guar Fluid

In this example, a treatment fluid containing a linear guar fluid, 2.4 g/L (20 ppt) guar, at 4.8 g/L (40 ppt) of fibers without particles was used. Non-modified PLA fiber and fibers containing silicones (OPS) were compared.

The bridge screening test results in 1 mm slot are presented in Table 2.

TABLE 2
Screening Bridge Testing.

| | Linear | Fiber | Fiber | Fiber |
|---|---|---|---|---|
| Flow rate, | velocity, | 12.4 microns | 12.4 microns | 9.1 microns |
| mL/min | cm/s | No OPS | 0.9 wt % OPS | 0.9 wt % OPS |
| 100 | 11.1 | Bridged | Bridged | Bridged |
| 200 | 22.2 | Bridged | Bridged | No Bridge |
| 300 | 33.3 | Bridged | Bridged | No Bridge |
| 400 | 44.4 | Bridged | No Bridge | No Bridge |
| 500 | 55.6 | Bridged | No Bridge | No Bridge |
| 600 | 66.7 | Bridged | No Bridge | No Bridge |
| 700 | 77.8 | No Bridge | No Bridge | No Bridge |
| 800 | 88.9 | No Bridge | No Bridge | No Bridge |

The foregoing data show that silicone modified fibers have improved non-bridging performance. Then, it may be observed that the diameter may also be used in order to further optimize non-bridging efficiency.

The foregoing disclosure and description is illustrative and explanatory, and it can be readily appreciated by those skilled in the art that various changes in the size, shape and materials, as well as in the details of the illustrated construction or combinations of the elements described herein can be made without departing from the spirit of the disclosure.

What is claimed is:

1. A diverting composition comprising a treatment fluid comprising non-bridging fibers and particles comprising a degradable material.

2. The composition of claim 1, wherein the fibers are crimped staple fibers.

3. The composition of claim 1, wherein the fibers contain 0.1 to 20 wt % silicones.

4. The composition of claim 3, wherein the fibers are crimped staple fibers.

5. The composition of claim 1, wherein the treatment fluid contains a blend including a first amount of particles having a first average particle size between about 3 mm and 2 cm and a second amount of particles having a second average size between about 1.6 and 20 times smaller than the first average particle size or a second amount of flakes having a second average size up to 10 times smaller than the first average particle size.

6. The composition of claim 1, wherein the fibers are dispersed in the treatment fluid in an amount effective to inhibit settling of the particles in said treatment fluid.

7. The composition of claim 1, wherein the treatment fluid comprises is a low viscosity fluid.

8. The composition of claim 3, wherein the silicone is a linear polysiloxane.

9. The composition of claim 3, wherein the silicone has an average molecular weight of from about 100 000 g/mol to about 900 000 g/mol.

10. The composition of claim 1 wherein the degradable material is a polylactic acid material or a polyglycolic acid.

11. The method according to claim 4 wherein the treatment fluid further comprises a third amount of particulates or flakes having a third average size smaller than the second average size.

12. The method of claim 11 wherein the treatment fluid further comprises a fourth and a fifth amount of particulates or flakes having a fourth average size smaller than the third average size, and a fifth average size smaller than the fourth average size.

13. The method according to claim 1 wherein the treatment fluid is such that a packed volume fraction of the blend exceeds 0.7.

14. A method of treating a subterranean formation penetrated by a well bore, comprising:
providing a treatment fluid comprising non-bridging fibers and particles comprising a degradable material,
introducing the treatment fluid into the well bore; and,
creating a plug with said treatment fluid.

15. The method according to claim 14 further comprising removing the plug.

16. The method of claim 14 wherein the method further comprises subjecting the subterranean formation to a fracturing treatment.

17. The method of claim 14 wherein the method further comprises subjecting the subterranean formation to a fracturing treatment after the creating of the plug.

18. A method of treating a subterranean formation of a well bore, wherein the well bore comprises a casing and at least one hole on said casing, said hole having a diameter, the method comprising:
providing a treatment fluid comprising non-bridging fibers and particles comprising a degradable material,
introducing the treatment fluid into the hole;
creating a plug of the hole with said treatment fluid; and
removing the plug,
wherein the treatment fluid contains a blend including a first amount of particles having a first average particle size between about 3 mm and 2 cm and a second amount of particles having a second average size between about 1.6 and 20 times smaller than the first average particle size or a second amount of flakes having a second average size up to 10 times smaller than the first average particle size.

19. The method of claim 18, wherein the fibers are crimped staple fibers.

20. The method of claim 19, wherein the fibers contain 0.1 to 20 wt % silicones.
